(19) United States
(12) Patent Application Publication
(10) Pub. No.: US 2026/0219453 A1
(43) Pub. Date: Jul. 30, 2026

(54) COATING STRIPPING DEVICE AND METHOD OF MANUFACTURING BLADE BODY

(71) Applicant: Fujikura Ltd., Tokyo (JP)

(72) Inventors: Sanga Sakanishi, Sakura-shi (JP); Yoshihiko Toda, Yamaga-shi (JP)

(73) Assignee: Fujikura Ltd., Tokyo (JP)

(21) Appl. No.: 19/159,110

(22) PCT Filed: Feb. 28, 2024
(86) PCT No.: PCT/JP2024/007344

§ 371 Date: Aug. 22, 2025

(30) Foreign Application Priority Data
Feb. 28, 2023 (JP) 2023-029611

(51) Int. Cl. G02B 6/245

(52) U.S. Cl. CPC G02B 6/245

(57) ABSTRACT

A coating stripping device for stripping a coating of an optical fiber includes: a first blade body having a first facing surface; a second blade body having a second facing surface that sandwiches the optical fiber in a facing direction together with the first facing surface; and positioning pins between the first facing surface and the second facing surface in the facing direction. A first fiber groove, into which the optical fiber is fitted to strip the coating, extends in an axial direction intersecting the facing direction. A first positioning groove, into which one of the positioning pins is fitted, extends in the axial direction and is disposed at a different position from the first fiber groove in an intersecting direction intersecting both the facing direction and the axial direction. The first fiber groove and the first positioning groove are open to the first facing surface.

### TECHNICAL FIELD

The present invention relates to a coating stripping device and a method of manufacturing a blade body.

Priority is claimed on Japanese Patent Application No. 2023-29611, filed in Japan on Feb. 28, 2023, the content of which is incorporated herein by reference.

### BACKGROUND

Patent Document 1 discloses a coating stripping device that strips a coating of an optical fiber. This coating stripping device includes a first blade body having a first fiber groove (first concave blade portion) and a second blade body having a second fiber groove (second concave blade portion). The coating is stripped by pulling out the optical fiber in a state where the first fiber groove and the second fiber groove sandwich the coating of the optical fiber.

In the coating stripping device described in Patent Document 1, in order to position the first fiber groove and the second fiber groove, the first blade body is provided with a protrusion portion (projection portion), and the second blade body is provided with a recess portion (recessed portion). By fitting the protrusion portion into the recess portion, the two fiber grooves are positioned.

### PATENT LITERATURE

### PTL 1

PCT International Publication No. WO2010/100912

In a coating stripping device that strips a coating by sandwiching an optical fiber between two fiber grooves, it is desirable that positions of the two fiber grooves accurately coincide with each other. This is because the optical fiber can be sandwiched with a uniform force and the coating can be easily stripped.

In order to accurately position the fiber groove in the coating stripping device of Patent Document 1, a shape of the protrusion portion and a shape of the recess portion need to accurately coincide with each other. However, it is difficult to perform processing of providing the protrusion portion on the blade body with accuracy, and there are cases where a manufacturing cost of the blade body increases.

### SUMMARY

One or more embodiments of the present invention provide a coating stripping device and a method of manufacturing a blade body capable of achieving both highly accurate positioning of a fiber groove and ease of manufacture.

A coating stripping device according to a first aspect of the present invention is a coating stripping device for stripping a coating of an optical fiber, including: a first blade body configured to have a first facing surface; a second blade body configured to have a second facing surface that sandwiches the optical fiber in a facing direction together with the first facing surface; and positioning pins configured to be disposed between the first facing surface and the second facing surface in the facing direction, in which a first fiber groove which extends in an axial direction intersecting the facing direction and into which the optical fiber is fitted to strip the coating, and a first positioning groove which is disposed at a position different from a position of the first fiber groove in an intersecting direction intersecting both the facing direction and the axial direction and extends in the axial direction and into which the positioning pin is fitted are open to the first facing surface, a second fiber groove which extends in the axial direction and into which the optical fiber is fitted to strip the coating, and a second positioning groove which extends in the axial direction and into which the positioning pin is fitted are open to the second facing surface, and a distance between the first fiber groove and the first positioning groove in the intersecting direction and a distance between the second fiber groove and the second positioning groove in the intersecting direction are substantially equal.

According to the first aspect of the present invention, the fiber grooves can be positioned by the positioning pin and the positioning grooves provided in the blade bodies. Therefore, for example, compared to a case where a positioning protrusion portion is provided in the blade body, highly accurate positioning of the fiber grooves and ease of manufacture are more easily realized.

In addition, according to a second aspect of the present invention, in the coating stripping device of the first aspect, at least one of the first blade body, the second blade body, and the positioning pin is movable.

According to the second aspect of the present invention, the accuracy of positioning the fiber grooves can be reliably improved.

In addition, according to a third aspect of the present invention, the coating stripping device of the first aspect or the second aspect further includes: a pressing portion that applies a pressing force to at least one of the first blade body and the second blade body in a direction in which the first facing surface and the second facing surface are brought closer to each other.

According to the third aspect of the present invention, a force with which the optical fiber is sandwiched between the fiber grooves can be made uniform, and the coating can be easily stripped.

In addition, according to a fourth aspect of the present invention, the coating stripping device of any one of the first aspect to the third aspect further includes: a gripping portion that grips the optical fiber and is relatively movable relative to the first blade body and the second blade body in the axial direction.

According to the fourth aspect of the present invention, the coating of the optical fiber can be easily stripped.

In addition, according to a fifth aspect of the present invention, the coating stripping device according to any one of the first aspect to the fourth aspect further includes: a positioning mechanism that positions the first blade body and the second blade body in the axial direction.

According to the fifth aspect of the present invention, in a case where the two blade bodies are shifted in the axial direction, the two blade bodies can be positioned in the axial direction.

In addition, a method of manufacturing a blade body according to a sixth aspect of the present invention is a method of manufacturing a blade body used in the coating stripping device according to any one of the first aspect to the fifth aspect, the method includes: preparing a first plate, which is to become the first blade body, and a second plate, which is to become the second blade body; and in a state in which the first plate and the second plate are overlapped with each other such that a first processed surface, which is to become the first facing surface in the first plate, and a second processed surface, which is to become the second facing surface in the second plate, are located on the same plane, simultaneously forming the first fiber groove on the first processed surface and the second fiber groove on the second processed surface, and simultaneously forming the first positioning groove on the first processed surface and the second positioning groove on the second processed surface.

According to the sixth aspect of the present invention, the first blade body and the second blade body used in the coating stripping device according to the aspects described above can be easily manufactured.

According to the above aspects of the present invention, it is possible to provide the coating stripping device and the method of manufacturing a blade body capable of achieving both highly accurate positioning of a fiber groove and ease of manufacture.

### BRIEF DESCRIPTION OF THE DRAWINGS

FIG. 1 is a perspective view showing a coating stripping device according to first embodiments.

FIG. 2 is a cross-sectional view taken along line II-II of FIG. 1.

FIG. 3 is an exploded view showing the coating stripping device according to the first embodiments.

FIG. 4A is a front view showing a case where the coating stripping device according to the first embodiments is in an open state.

FIG. 4B is a front view showing a case where the coating stripping device according to the first embodiments is in a closed state.

FIG. 5A is an enlarged view showing a first blade body and a second blade body according to the first embodiments.

FIG. 5B is a view showing an example of a method of manufacturing the first blade body and the second blade body according to the first embodiments.

FIG. 6 is a cross-sectional view taken along line VI-VI of FIG. 4B.

FIG. 7 is a cross-sectional view taken along line VII-VII of FIG. 4B.

FIG. 8 is a rear view of a first guide plate and a second guide plate according to the first embodiments.

FIG. 9A is a view showing an action of the first guide plate and the second guide plate according to the first embodiments.

FIG. 9B is a view showing a state subsequent to FIG. 9A.

FIG. 10A is a view showing an action of a first tapered surface and a second tapered surface according to the first embodiments.

FIG. 10B is a view showing a state subsequent to FIG. 10A.

FIG. 11A is a front view showing a case where a coating stripping device according to second embodiments is in an open state.

FIG. 11B is a front view showing a case where the coating stripping device according to the second embodiments is in a closed state.

FIG. 12 is a view showing a first blade body and a second blade body according to a modification example.

### DETAILED DESCRIPTION

### First Embodiments

Hereinafter, an optical fiber coating stripping device of first embodiments will be described with reference to the drawings.

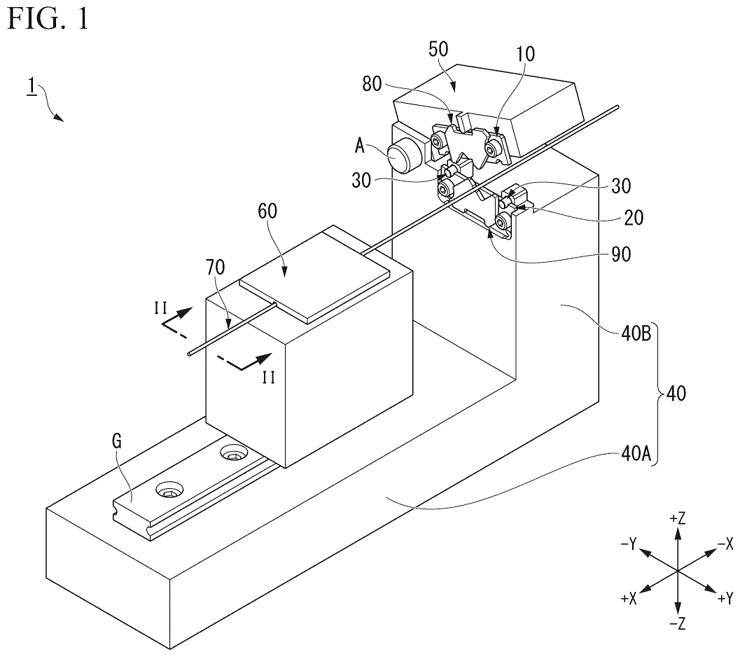

As shown in FIG. 1, a coating stripping device 1 according to one or more embodiments includes a first blade body 10, a second blade body 20, positioning pins 30, a base 40, a rotating portion 50, and a gripping portion 60 (i.e., grip), a first guide plate 80, and a second guide plate 90.

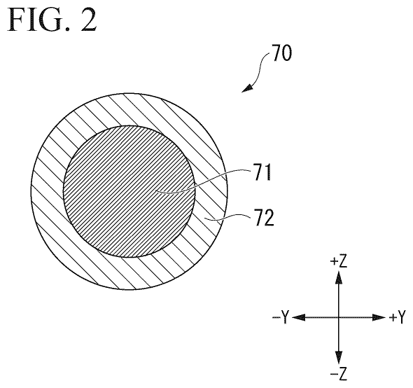

The coating stripping device 1 is used, for example, for an optical fiber 70 as shown in FIG. 2. The optical fiber 70 in the shown example has a bare fiber portion 71 and a coating 72. The bare fiber portion 71 has, for example, a core and a cladding. The coating 72 is a resin material that covers the bare fiber portion 71. The coating stripping device 1 is a device for stripping the coating 72 of the optical fiber 70 using the first blade body 10 and the second blade body 20.

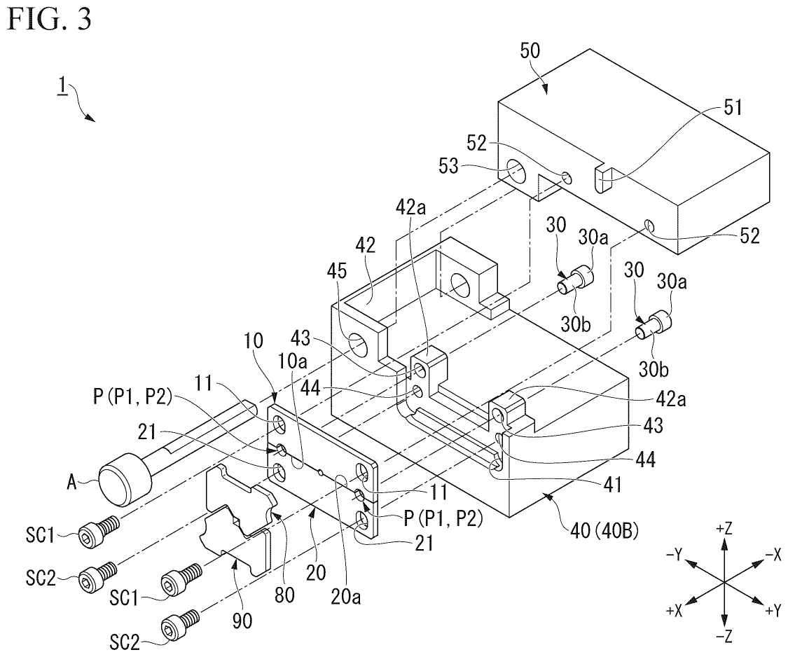

As shown in FIG. 3, each of the blade bodies 10 and 20 has a flat plate shape with a thickness of about 1 mm. The first blade body 10 has a first facing surface (first facing edge portion) 10a. The second blade body 20 has a second facing surface (facing edge portion) 20a.

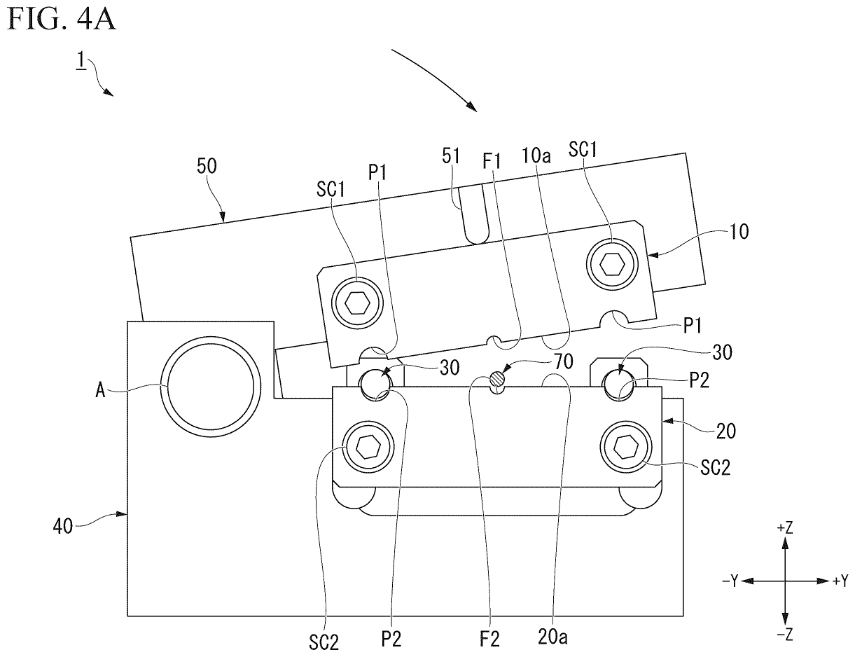

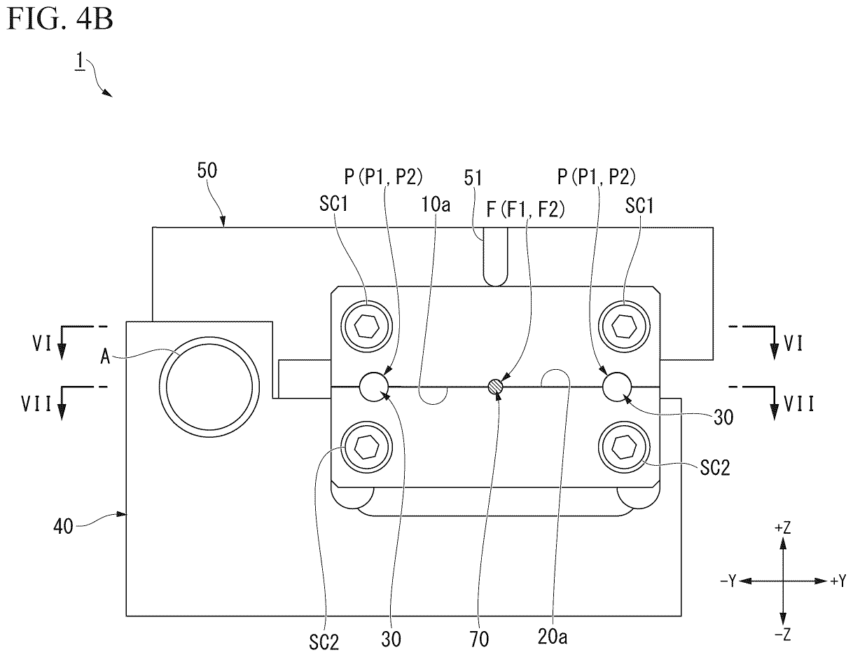

The coating stripping device 1 (the blade bodies 10 and 20) according to one or more embodiments can have two states: a closed state and an open state. The closed state is a state in which the optical fiber 70 is sandwiched between the first facing surface 10a (first blade body 10) and the second facing surface 20a (second blade body 20) (see FIG. 4B). In one or more embodiments, the first facing surface 10a and the second facing surface 20a are in contact with each other in the closed state. The open state is a state in which the first facing surface 10a and the second facing surface 20a do not face each other, and the optical fiber 70 is not sandwiched between the first facing surface 10a and the second facing surface 20a (see FIGS. 1 and 4A). Hereinafter, unless otherwise specified, a positional relationship of each member in a case where the coating stripping device 1 (the blade bodies 10 and 20) is in the closed state is described.

### Definition of Directions

In the present specification, a direction in which the optical fiber 70 is sandwiched between the first facing surface 10a (first blade body 10) and the second facing surface 20a (second blade body 20) is referred to as a facing direction Z. The facing direction Z is also a direction in which the first facing surface 10a (first blade body 10) and the second facing surface 20a (second blade body 20) face each other in the closed state. One direction intersecting (for example, orthogonal to) the facing direction Z is referred to as an axial direction X. A direction intersecting (for example, orthogonal to) both the facing direction Z and the axial direction X is referred to as an intersecting direction Y. In one or more embodiments, the axial direction X is also a thickness direction (a direction intersecting the blade bodies 10 and 20) of the blade bodies 10 and 20 formed in a flat plate shape, and the intersecting direction Y and the facing direction Z are also directions in which the blade bodies 10 and 20 extend. In addition, a direction from the second facing surface 20a toward the first facing surface 10a along the facing direction Z is referred to as a +Z direction or upward. A direction opposite to the +Z direction is referred to as a −Z direction or downward. One direction along the intersecting direction Y is referred to as a +Y direction or rightward. A direction opposite to the +Y direction is referred to as a −Y direction or leftward. One direction along the axial direction X is referred to as a +X direction or forward. A direction opposite to the +X direction is referred to as a −X direction or rearward.

As shown in FIGS. 4A and 4B, a first fiber groove F1 and two first positioning grooves P1 are open to the first facing surface 10a. The optical fiber 70 is fitted into the first fiber groove F1, and each of the two positioning pins 30 is fitted into the respective one of the first positioning grooves P1 (details will be described later).

In the shown example, the first fiber groove F1 is located at a center portion of the first facing surface 10a in the intersecting direction Y. The first positioning grooves P1 are disposed at positions different from that of the first fiber groove F1 in the intersecting direction Y. In the shown example, the two first positioning grooves P1 are disposed so that the first fiber groove F1 is interposed therebetween in the intersecting direction Y.

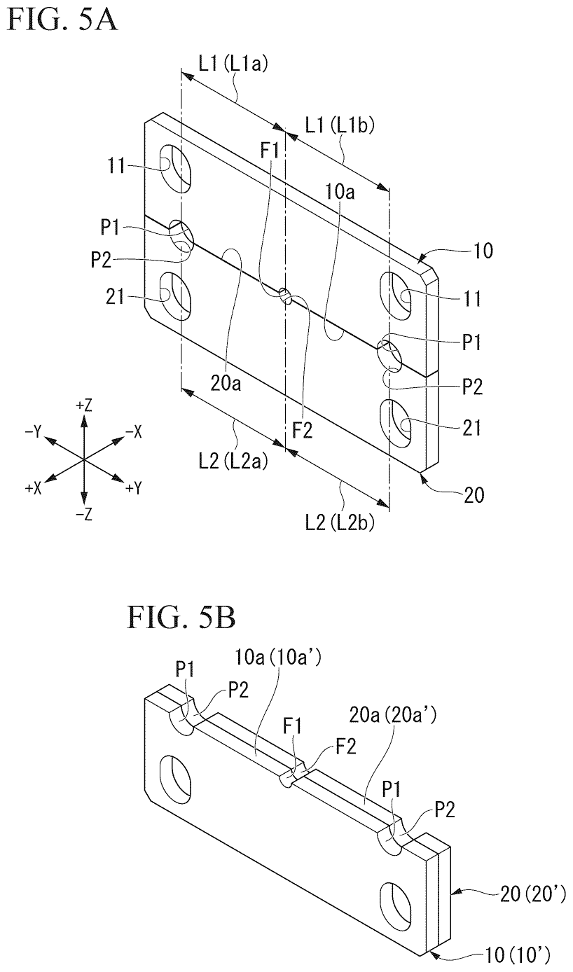

As shown in FIG. 5A, the first fiber groove F1 and each of the first positioning grooves P1 extend in the axial direction X and pass through the first blade body 10 in the axial direction X. The first fiber groove F1 has, for example, a U-shape (semicircular shape) when viewed in the axial direction X. Similarly, each of the first positioning grooves P1 has, for example, a U-shape (semicircular shape) when viewed in the axial direction X. In addition, a first through hole 11 that passes through the first blade body 10 in the axial direction X is formed in each of both end portions of the first blade body 10 in the intersecting direction Y.

As shown in FIGS. 4A and 4B, a second fiber groove F2 and two second positioning grooves P2 are open to the second facing surface 20a. The optical fiber 70 is fitted into the second fiber groove F2, and each of the two positioning pins 30 is fitted into the respective one of the second positioning grooves P2 (details will be described later).

In the shown example, the second fiber groove F2 is located at a central portion of the second facing surface 20a in the intersecting direction Y. The second positioning grooves P2 are disposed at positions different from that of the second fiber groove F2 in the intersecting direction Y. In the shown example, the two second positioning grooves P2 are disposed so that the second fiber groove F2 is interposed therebetween in the intersecting direction Y.

As shown in FIG. 5A, the second fiber groove F2 and each of the second positioning grooves P2 extends in the axial direction X and pass through the second blade body 20 in the axial direction X. The second fiber groove F2 has, for example, a U-shape (semicircular shape) when viewed in the axial direction X. Similarly, each of the second positioning grooves P2 has, for example, a U-shape (semicircular shape) when viewed in the axial direction X. In addition, a second through hole 21 that passes through the second blade body 20 in the axial direction X is formed in each of both end portions of the second blade body 20 in the intersecting direction Y.

As shown in FIG. 4B, when the coating stripping device 1 is in the closed state, the second fiber groove F2 faces the first fiber groove F1 in the facing direction Z. By bringing the first facing surface 10a and the second facing surface 20a into contact with each other in this state, the first fiber groove F1 and the second fiber groove F2 form one fiber hole F. When viewed in the axial direction X, the fiber hole F has, for example, a circular shape.

The fiber grooves F1 and F2 are formed such that an inner diameter of the fiber hole F is smaller than an outer diameter of the coating 72 of the optical fiber 70 and larger than an outer diameter of the bare fiber portion 71. Accordingly, the fiber grooves F1 and F2 strip only the coating 72 from the optical fiber 70 without damaging the bare fiber portion 71.

In addition, when the coating stripping device 1 is in the closed state, each of the second positioning grooves P2 faces respective one of the first positioning grooves P1 in the facing direction Z. By bringing the first facing surface 10a and the second facing surface 20a into contact with each other in this state, each of sets of the positioning grooves P1 and P2 located on right and left sides of the fiber grooves F1 and F2 forms a positioning hole P. When viewed in the axial direction X, the positioning hole P has, for example, a circular shape.

The positioning pin 30 is disposed between the first facing surface 10a (first positioning groove P1) and the second facing surface 20a (second positioning groove P2) in the facing direction Z. The positioning grooves P1 and P2 are formed such that an inner diameter of the positioning hole P is substantially equal to an outer diameter of the positioning pin 30 (more specifically, a small-diameter portion 30b, which will be described later). The phrase “substantially equal” in the present specification includes a case where there is an error (about several μm) to the extent that the fiber grooves F1 and F2 can be sufficiently positioned (described later). The same applies to the subsequent description.

As shown in FIG. 5A, in one or more embodiments, a distance L1 between the first fiber groove F1 and the first positioning groove P1 in the intersecting direction Y is substantially equal to a distance L2 between the second fiber groove F2 and the second positioning groove P2 in the intersecting direction Y. This is to ensure accurate positioning (center alignment) of the fiber grooves F1 and F2 when the coating stripping device 1 is in the closed state.

More specifically, the “distance L1 between the first fiber groove F1 and the first positioning groove P1 in the intersecting direction Y” means the distance L1 in the intersecting direction Y between a center of the first fiber groove F1 in the intersecting direction Y and a center of the first positioning groove P1 in the intersecting direction Y. Similarly, more specifically, the “distance L2 between the second fiber groove F2 and the second positioning groove P2 in the intersecting direction Y” means the distance L2 in the intersecting direction Y between a center of the second fiber groove F2 in the intersecting direction Y and a center of the second positioning groove P2 in the intersecting direction Y.

In addition, in the shown example, a distance L1a and a distance L1b may be equal or may not be equal to each other. The distance L1a is the distance L1 between the first positioning groove P1 located on the left side of the two first positioning grooves P1 and the first fiber groove F1. The distance L1b is the distance L1 between the first positioning groove P1 located on the right side and the first fiber groove F1. Similarly, a distance L2a and a distance L2b may be equal or may not be equal to each other. The distance L2a is the distance L2 between the second positioning groove P2 located on the left side of the two second positioning grooves P2 and the second fiber groove F2. The distance L2b is the distance L2 between the second through hole 21 located on the right side and the second fiber groove F2. Even in these cases, the distance L1a and the distance L2a are substantially equal to each other, and the distance L1b and the distance L2b are substantially equal to each other, thereby realizing highly accurate positioning as described above.

An example of a method of manufacturing the blade bodies 10 and 20 in which the distance L1 and the distance L2 are substantially equal to each other will be described with reference to FIG. 5B.

First, a first plate 10′, which is to become the first blade body 10, and a second plate 20′, which is to become the second blade body 20, are prepared. The first plate 10′ has a first processed surface 10a′, which is to become the first facing surface 10a. The second plate 20′ has a second processed surface 20a′, which is to become the second facing surface 20a. The plates 10′ and 20′ may be, for example, metal plates or ceramic plates.

Next, as shown in FIG. 5B, the first blade body 10 and the second blade body 20 are overlapped with each other such that the first processed surface 10a′ and the second processed surface 20a′ are located on the same plane.

Next, in this overlapping state in which the plates 10′ and 20′ are overlapped in this manner, the first fiber groove F1 in the first processed surface 10a′ and the second fiber groove F2 in the second processed surface 20a′ are simultaneously formed (processed integrally). In other words, the first fiber groove F1 opening at the first processed surface 10a′ and the second fiber groove F2 opening at the second processed surface 20a′ are simultaneously formed (processed integrally). Similarly, in a state where the plates 10′ and 20′ are overlapped, the first positioning groove P1 on the first processed surface 10a′ and the second positioning groove P2 on the second processed surface 20a′ are simultaneously formed (processed integrally). In other words, the first positioning groove P1 that is open to the first processed surface 10a′ and the second positioning groove P2 that is open to the second processed surface 20a′ are simultaneously formed (processed integrally). The formation of the fiber grooves F1 and F2 and the formation of the positioning grooves P1 and P2 are performed by, for example, cutting using a ball end mill, or grinding using a wheel.

By performing such processing, a position of the first fiber groove F1 and a position of the second fiber groove F2 can be accurately coincident with each other (substantially equal to each other) in a direction (intersecting direction Y) intersecting a direction in which the plates 10′ and 20′ are overlapped. Similarly, a position of the first positioning groove P1 and a position of the second positioning groove P2 can be accurately coincident with each other (substantially equal to each other) in the direction (intersecting direction Y) intersecting the direction in which the plates 10′ and 20′ are overlapped. Therefore, the blade bodies 10 and 20 in which the distance L1 and the distance L2 are substantially equal to each other can be easily manufactured.

As shown in FIG. 1, the base 40 according to one or more embodiments includes a base portion 40A and a protruding portion 40B. The base portion 40A is, for example, a portion to be placed on a workbench or the like. The protruding portion 40B is a portion that protrudes upward from a rear end portion of the base portion 40A. The base 40 according to one or more embodiments has an L-shape when viewed in the intersecting direction Y, by including the base portion 40A and the protruding portion 40B. The first blade body 10, the second blade body 20, the positioning pins 30, the rotating portion 50, the first guide plate 80, and the second guide plate 90 are provided at a tip portion (upper end portion) of the protruding portion 40B.

As shown in FIG. 3, the protruding portion 40B (base 40) has a first shaft hole 45. The first shaft hole 45 is located at a left end portion of the protruding portion 40B. The rotating portion 50 has a second shaft hole 53. The second shaft hole 53 is located at a left end portion of the rotating portion 50. A shaft body A extending in the axial direction X is inserted into the shaft holes 45 and 53. Accordingly, the rotating portion 50 is configured to be capable of rotating relative to the protruding portion 40B (base 40) about the shaft body A as a rotation axis. In one or more embodiments, the above-described open state and closed state are switched by the rotating portion 50 rotating relative to the protruding portion 40B (base 40). An avoidance recess portion 42 for preventing interference between the rotating portion 50 and the base 40 is formed on an upper surface of the protruding portion 40B.

Two screw holes (first screw holes) 52 are open to a front surface of the rotating portion 50. The two first screw holes 52 are disposed at an interval therebetween in the intersecting direction Y. A screw SC1 (first screw SC1) is screwed into each of the first screw holes 52 from the front through the first through hole 11 of the first blade body 10.

A pressing portion 51 (i.e., press) is provided on the front surface of the rotating portion 50. The pressing portion 51 applies a pressing force to the first blade body 10 in a direction in which the first facing surface 10a and the second facing surface 20a are brought closer to each other. Although not shown in detail, the pressing portion 51 has an urging member that urges the first blade body 10 downward. Accordingly, the pressing portion 51 applies an elastic pressing force (urging force) directed downward to the first blade body 10 (see also FIGS. 4A and 4B). The pressing portion 51 and the first fiber groove F1 may be at substantially the same position in the intersecting direction Y.

As shown in FIG. 3, a fixed recess portion 41 that is recessed rearward is formed on a front surface of the protruding portion 40B. The second blade body 20 is fitted into the fixed recess portion 41. Two screw holes (second screw holes) 44 are open to a surface of the fixed recess portion 41 facing forward. The two second screw holes 44 are disposed at an interval therebetween in the intersecting direction Y. A screw SC2 (second screw SC2) is screwed into each of the second screw holes 44 from the front through the second through hole 21 of the second blade body 20.

The second screw SC2 fixes the second blade body 20 to the protruding portion 40B (base 40). That is, the second screw SC2 restricts a shift (relative movement) between the second blade body 20 and the protruding portion 40B in the axial direction X, the intersecting direction Y, and the facing direction Z. On the other hand, the first screw SC1 maintains the first blade body 10 in a movable state in the intersecting direction Y and the facing direction Z while restricting the first blade body 10 from falling off the rotating portion 50. In other words, the first blade body 10 is not completely fixed to the rotating portion 50, and is attached in a state in which a shift in the intersecting direction Y and the facing direction Z is allowed.

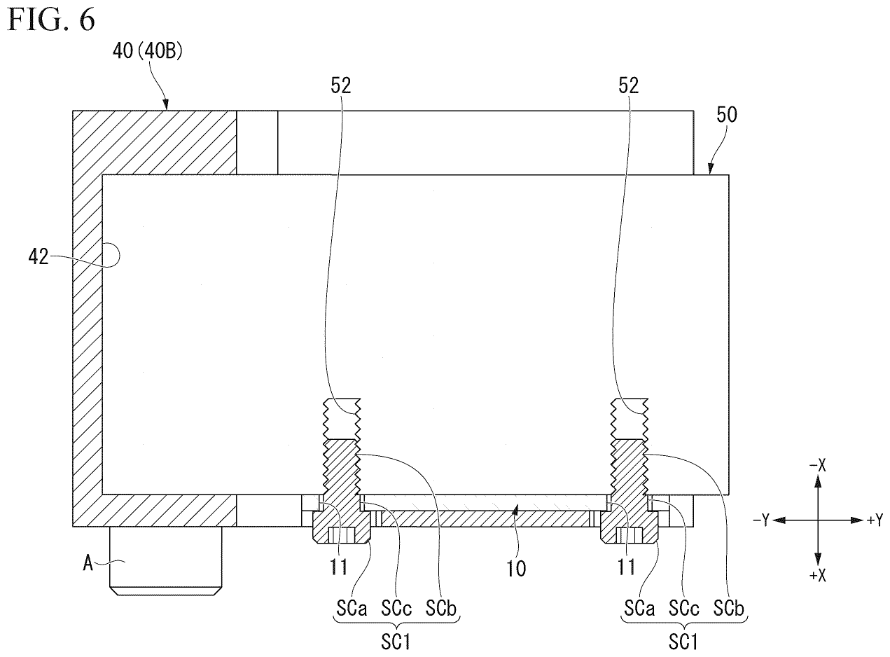

Specifically, in one or more embodiments, as shown in FIG. 6, a stepped screw is adopted as the first screw SC1. That is, the first screw SC1 according to one or more embodiments includes, in addition to a screwing portion SCb having spiral projections formed on an outer peripheral surface and a head portion SCa having a diameter larger than that of the screwing portion SCb, an intermediate portion SCc disposed between the head portion SCa and the screwing portion SCb. No spiral projection such as the screwing portion SCb is provided on an outer peripheral surface of the intermediate portion SCc, and the intermediate portion SCc is not screwed into the first screw hole 52. Accordingly, a gap in the axial direction X is secured between the head portion SCa and the front surface of the rotating portion 50. The first blade body 10 is disposed in the gap in the axial direction X.

The first blade body 10 is formed such that an inner diameter of the first through hole 11 is larger than an outer diameter of the intermediate portion SCc. Accordingly, a gap in the intersecting direction Y and the facing direction Z is generated between the intermediate portion SCc and the first through hole 11. The first blade body 10 is movable in the intersecting direction Y and the facing direction Z within a range of the gap. In other words, within the range of the gap, the first blade body 10 is not completely fixed to the rotating portion 50 and can relatively be moved (shifted) in the intersecting direction Y and the facing direction Z. As the second screw SC2, for example, an ordinary screw, that is, a screw having the head portion SCa and the screwing portion SCb and not having the intermediate portion SCc can be adopted.

As shown in FIG. 3, a pair of projection portions 42a protruding upward are provided at a front end portion of the avoidance recess portion 42. The pair of projection portions 42a are disposed at an interval therebetween in the intersecting direction Y. A front surface of the projection portion 42a is located on the same plane as the surface of the fixed recess portion 41 facing forward.

An insertion hole 43 that passes through the projection portion 42a in the axial direction X is formed in each of the projection portions 42a. The positioning pin 30 is inserted into the insertion hole 43 from the rear. The positioning pin 30 according to one or more embodiments has a large-diameter portion 30a and the small-diameter portion 30b having a smaller diameter than the large-diameter portion 30a. Each of the large-diameter portion 30a and the small-diameter portion 30b has a columnar shape. In one or more embodiments, the positioning pin 30 is inserted into the insertion hole 43 in a state of being movable in the intersecting direction Y and the facing direction Z. In other words, the positioning pin 30 is inserted into the insertion hole 43 in a state in which a shift in the intersecting direction Y and the facing direction Z is allowed.

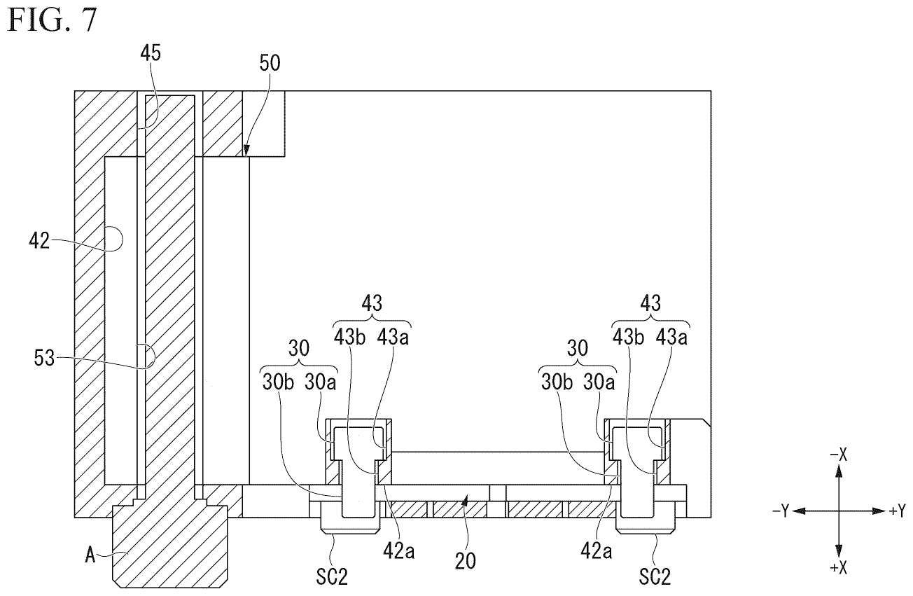

Specifically, in one or more embodiments, as shown in FIG. 7, the insertion hole 43 has a large-diameter portion 43a and a small-diameter portion 43b having a smaller diameter than the large-diameter portion 43a. The large-diameter portion 43a is open to a rear surface of the projection portion 42a. The small-diameter portion 43b is open on the front surface of the projection portion 42a. The large-diameter portion 43a and the small-diameter portion 43b communicate with each other in the axial direction X. The small-diameter portion 30b of the positioning pin 30 is inserted into the small-diameter portion 43b of the insertion hole 43. The large-diameter portion 30a of the positioning pin 30 is inserted into the large-diameter portion 43a of the insertion hole 43.

The insertion hole 43 is formed such that an inner diameter of the insertion hole 43 is larger than the outer diameter of the positioning pin 30. Specifically, the insertion hole 43 is formed such that an inner diameter of the large-diameter portion 43a is larger than an outer diameter of the large-diameter portion 30a and an inner diameter of the small-diameter portion 43b is larger than an outer diameter of the small-diameter portion 30b. Accordingly, a gap in the intersecting direction Y and the facing direction Z is generated between the positioning pin 30 and the insertion hole 43. The positioning pin 30 is movable in the intersecting direction Y and the facing direction Z within a range of the gap. In other words, within the range of the gap, the positioning pin 30 can relatively be moved (shifted) relative to the base 40 in the intersecting direction Y and the facing direction Z.

As shown in FIG. 7, the inner diameter of the small-diameter portion 43b of the insertion hole 43 may be smaller than the outer diameter of the large-diameter portion 30a of the positioning pin 30. In this dimensional relationship, the positioning pin 30 can be restricted from falling forward from the insertion hole 43.

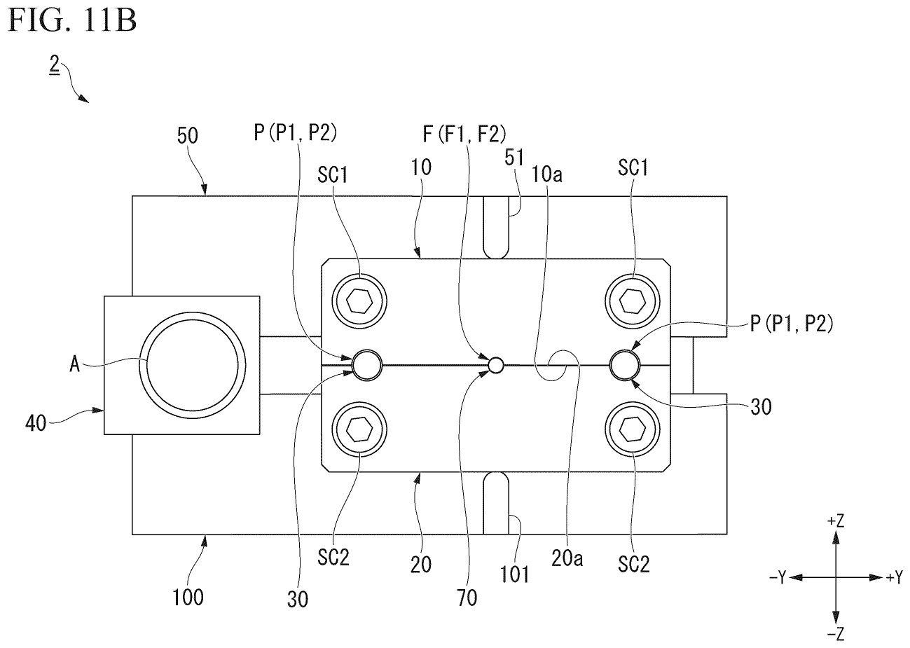

As shown in FIGS. 1 and 3, the first guide plate 80 is fixed to a front surface of the first blade body 10. The second guide plate 90 is fixed to a front surface of the second blade body 20. Fixing means (not shown) for fixing the guide plates 80 and 90 to the blade bodies 10 and 20 is not particularly limited, and can be appropriately selected from known means such as screwing and heat melting. In FIGS. 4A and 4B (and FIGS. 11A and 11B), illustration of the guide plates 80 and 90 is omitted.

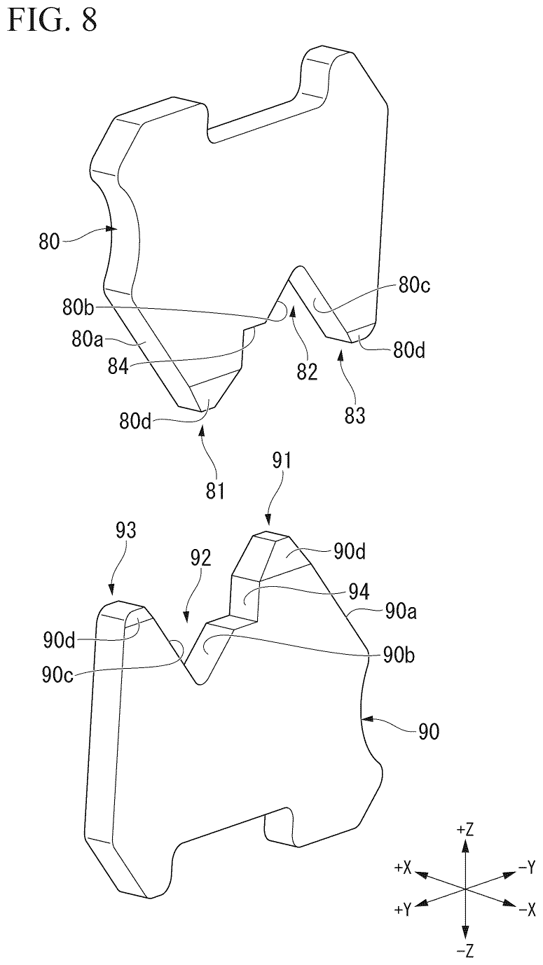

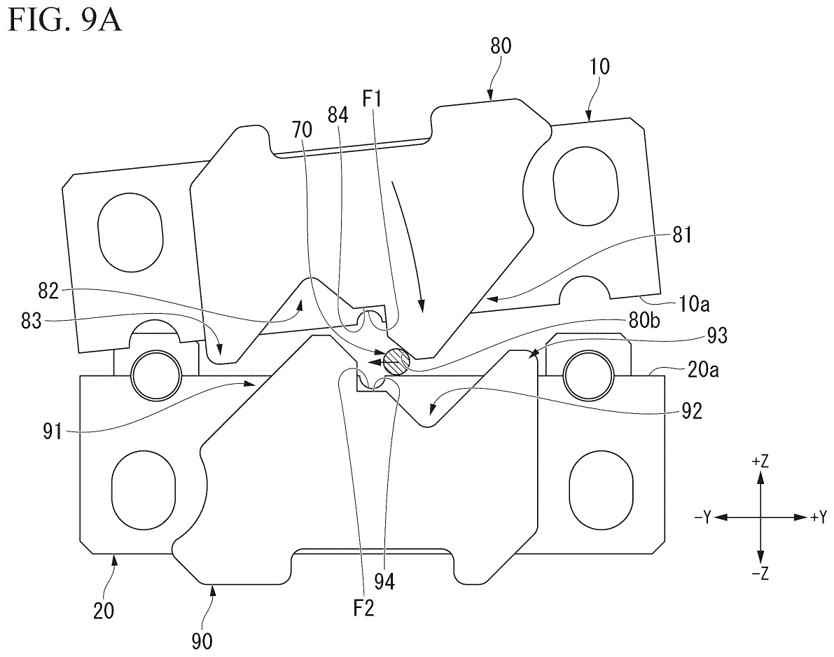

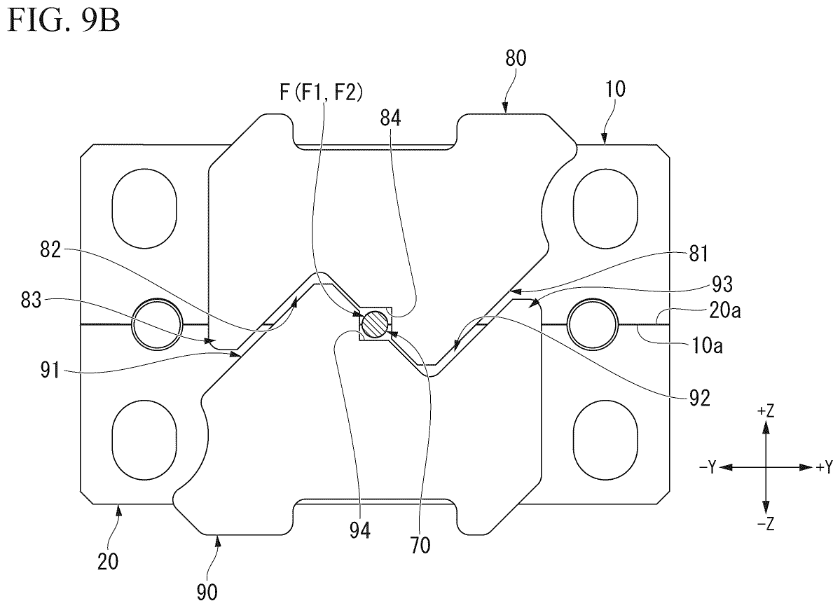

As shown in FIG. 8, a first protrusion portion 81, a first recess portion 82, and a first auxiliary protrusion portion 83 are provided in a lower portion of the first guide plate 80. The first protrusion portion 81 and the first auxiliary protrusion portion 83 have shapes protruding downward. The first recess portion 82 is located between the first protrusion portion 81 and the first auxiliary protrusion portion 83 in the intersecting direction Y and has a shape that is recessed upward. Accordingly, a lower surface of the first guide plate 80 according to one or more embodiments has an S-shape when viewed in the axial direction X. A tip portion (lower end portion) of the first protrusion portion 81 and a tip portion (lower end portion) of the first auxiliary protrusion portion 83 are located below the first facing surface 10a of the first blade body 10 (see FIGS. 9A and 9B).

Specifically, as shown in FIG. 8, the first guide plate 80 has inclined surfaces 80a to 80c. The inclined surface 80a connects a right side surface (+Y side surface) of the first guide plate 80 and the lower surface of the first guide plate 80, and is inclined downward as the inclined surface 80a goes to the left (−Y side). The inclined surface 80b extends from a vicinity of a lower end portion of the inclined surface 80a, and is inclined upward as the inclined surface 80b goes to the left. An L-shaped notch 84 is formed in a center portion of the inclined surface 80b. The inclined surface 80c extends from a vicinity of an upper end portion of the inclined surface 80b, and is inclined downward as the inclined surface 80c goes to the left. The above-described first protrusion portion 81 is a protrusion portion having the inclined surface 80a and the inclined surface 80b. The first recess portion 82 is a recess portion surrounded by the inclined surface 80b and the inclined surface 80c. The first auxiliary protrusion portion 83 is a protrusion portion having the inclined surface 80c and a left side surface (−Y side surface) of the first guide plate 80.

As shown in FIGS. 9A and 9B, the notch 84 is disposed at a position overlapping the first fiber groove F1 when viewed in the axial direction X. By forming the notch 84, the first guide plate 80 is prevented from interfering with the optical fiber 70 in the closed state.

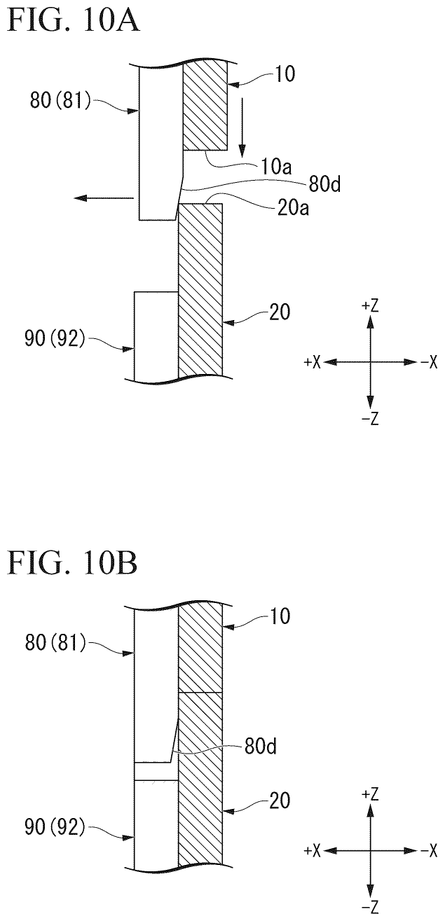

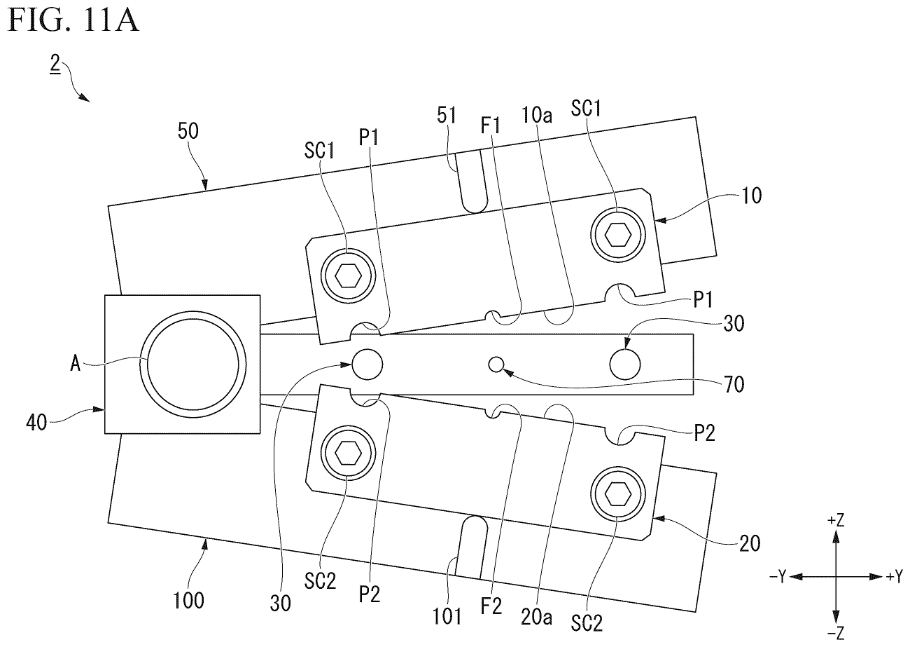

As shown in FIG. 8, a first tapered surface 80d is formed at each of the tip portion (lower end portion) of the first protrusion portion 81 and the tip portion (lower end portion) of the first auxiliary protrusion portion 83. As shown in FIGS. 10A and 10B, the first tapered surface 80d is located below the first facing surface 10a of the first blade body 10. The first tapered surface 80d connects a rear surface of the first guide plate 80 and the lower surface of the first guide plate 80, and is inclined forward as the first tapered surface 80d goes downward.

As shown in FIG. 8, a second protrusion portion 91, a second recess portion 92, and a second auxiliary protrusion portion 93 are provided in an upper portion of the second guide plate 90. The second protrusion portion 91 and the second auxiliary protrusion portion 93 have shapes protruding upward. The second recess portion 92 is located between the second protrusion portion 91 and the second auxiliary protrusion portion 93 in the intersecting direction Y and has a shape that is recessed downward. Accordingly, an upper surface of the second guide plate 90 according to one or more embodiments has an S-shape when viewed in the axial direction X. A tip portion (upper end portion) of the second protrusion portion 91 and a tip portion (upper end portion) of the second auxiliary protrusion portion 93 are located above the second facing surface 20a of the second blade body 20 (see FIGS. 9A and 9B).

Specifically, as shown in FIG. 8, the second guide plate 90 has inclined surfaces 90a to 90c. The inclined surface 90a connects a left side surface (−Y side surface) of the second guide plate 90 and the upper surface of the second guide plate 90, and is inclined upward as the inclined surface 90a goes to the right (+Y side). The inclined surface 90b extends from a vicinity of an upper end portion of the inclined surface 90a, and is inclined downward as the inclined surface 90b goes to the right. An L-shaped notch 94 is formed in a center portion of the inclined surface 90b. The inclined surface 90c extends from a vicinity of a lower end portion of the inclined surface 90b, and is inclined upward as the inclined surface 90b goes to the right. The above-described second protrusion portion 91 is a protrusion portion having the inclined surface 90a and the inclined surface 90b. The second recess portion 92 is a recess portion surrounded by the inclined surface 90b and the inclined surface 90c. The second auxiliary protrusion portion 93 is a protrusion portion having the inclined surface 90c and a right side surface (+Y side surface) of the second guide plate 90.

As shown in FIGS. 9A and 9B, the notch 94 is disposed at a position overlapping the second fiber groove F2 when viewed in the axial direction X. By forming the notch 94, the second guide plate 90 is prevented from interfering with the optical fiber 70 in the closed state (see FIG. 9B).

As shown in FIG. 8, a second tapered surface 90d is formed at each of the tip portion (upper end portion) of the second protrusion portion 91 and the tip portion (upper end portion) of the second auxiliary protrusion portion 93. Although not shown in detail, the second tapered surface 90d is located above the second facing surface 20a of the second blade body 20. The second tapered surface 90d connects a rear surface of the second guide plate 90 and the upper surface of the second guide plate 90, and is inclined forward as the second tapered surface 90d goes upward.

As shown in FIGS. 9A and 9B, in the closed state, the first protrusion portion 81 of the first guide plate 80 is inserted into the second recess portion 92 of the second guide plate 90, and the second protrusion portion 91 of the second guide plate 90 is inserted into the first recess portion 82 of the first guide plate 80. In this state, a gap in the facing direction Z may be secured between the first guide plate 80 and the second guide plate 90.

As shown in FIG. 1, the gripping portion 60 grips the optical fiber 70. The gripping portion 60 is disposed in front of the blade bodies 10 and 20. The gripping portion 60 is configured to be linearly movable in the axial direction X. Accordingly, the gripping portion 60 is configured to be relatively movable relative to the blade bodies 10 and 20 in the axial direction X. The gripping portion 60 according to one or more embodiments linearly moves in the axial direction X along a linear motion guide G provided on an upper surface of the base portion 40A.

The gripping portion 60 grips the optical fiber 70. By separating the gripping portion 60 from the blade bodies 10 and 20 in the axial direction X in a state in which the coating 72 of the optical fiber 70 is sandwiched between the fiber grooves F1 and F2 (in the fiber hole F), the optical fiber 70 is pulled forward, and the coating 72 is stripped. In a case of manually pulling the optical fiber 70, the coating stripping device 1 may not include the gripping portion 60.

Next, an action of the coating stripping device 1 configured as described above will be described.

When stripping the coating 72 of the optical fiber 70 using the coating stripping device 1 according to one or more embodiments, first, as shown in FIG. 4A, the coating stripping device 1 is placed in the open state. Then, the optical fiber 70 gripped by the gripping portion 60 is disposed between the first fiber groove F1 of the first blade body 10 and the second fiber groove F2 of the second blade body 20. More specifically, the optical fiber 70 is placed on the first fiber groove F1. In this case, each of the positioning pins 30 is disposed between the respective one of the first positioning grooves P1 and the second positioning grooves P2. More specifically, each of the positioning pins 30 is placed on the respective one of the second positioning grooves P2. Furthermore, as described above, the first blade body 10 and the positioning pin 30 are in a movable state.

Next, as shown in FIG. 4B, the rotating portion 50 is closed to transition the coating stripping device 1 to the closed state. At this time, the optical fiber 70 is fitted into the fiber grooves F1 and F2, and is sandwiched between the fiber grooves F1 and F2. In this state, the gripping portion 60 moves forward along the linear motion guide G, so that the coating 72 is torn off by the fiber grooves F1 and F2, and the torn coating 72 is stripped from the optical fiber 70. In a portion from which the coating 72 is stripped, the bare fiber portion 71 is exposed to the outside.

When the coating stripping device 1 is transitioned to the closed state, each of the positioning pins 30 in a movable state is fitted into the respective one of the second positioning grooves P2 by the pressing force received from the first blade body 10, and is fixed to the respective one of the second positioning grooves P2. In addition, the first blade body 10 in a movable state is fixed at the position where each of the positioning pins 30 and the respective one of the first positioning grooves P1 is fitted to each other by the pressing force received from the pressing portion 51. Here, as described above, since the distance L1 and the distance L2 are substantially equal (see also FIG. 5A), when the first blade body 10 and the positioning pins 30 are fixed, the first fiber groove F1 and the second fiber groove F2 are positioned with high accuracy. Therefore, the optical fiber 70 can be sandwiched between the fiber grooves F1 and F2 with a uniform force, and the coating 72 can be easily stripped.

As described above, according to the coating stripping device 1 of one or more embodiments, the fiber grooves F1 and F2 can be positioned by the positioning pins 30 and the positioning grooves P1 and P2 provided in the blade bodies 10 and 20. In general, processing of providing groove shapes (recessed shapes) such as the fiber grooves F1 and F2 in the blade bodies can be performed more easily and more accurately than processing of providing a positioning protrusion portion (refer to, for example, Patent Document 1) in a blade body. Therefore, according to the coating stripping device 1 of one or more embodiments, it is possible to achieve both the highly accurate positioning of the fiber grooves F1 and F2 and ease of manufacture.

In the above-described procedure of sandwiching the optical fiber 70 between the fiber grooves F1 and F2, the guide plates 80 and 90 according to one or more embodiments have a role of guiding the optical fiber 70 to the fiber grooves F1 and F2 in the intersecting direction Y. For example, in a case where the optical fiber 70 is shifted to the right (+Y side) with respect to the fiber grooves F1 and F2, as shown in FIG. 9A, the inclined surface 80b of the first guide plate 80 comes into contact with the optical fiber 70 before the first facing surface 10a comes into contact with the optical fiber 70. Then, the inclined surface 80b presses the optical fiber 70 to the left (−Y side), and as shown in FIG. 9B, the optical fiber 70 is guided to the fiber grooves F1 and F2.

In addition, in the same procedure, the guide plates 80 and 90 according to one or more embodiments also have a role of positioning the blade bodies 10 and 20 in the axial direction X. For example, in a case where the first blade body 10 is shifted to the rear with respect to the second blade body 20, as shown in FIG. 10A, the first tapered surface 80d of the first guide plate 80 comes into contact with the second blade body 20 before the first facing surface 10a comes into contact with the second facing surface 20a. Then, the second blade body 20 presses the first tapered surface 80d forward, and the first blade body 10 is also pushed forward. Accordingly, as shown in FIG. 10B, the blade bodies 10 and 20 are positioned in the axial direction X. Although not shown in detail, in a case where the second blade body 20 is shifted to the rear with respect to the first blade body 10, the blade bodies 10 and 20 are positioned in the axial direction X by the second tapered surface 90d of the second guide plate 90. That is, the first tapered surface 80d and the second tapered surface 90d function as positioning mechanisms (i.e., positioners) that position the first blade body 10 and the second blade body 20 in the axial direction X.

In the above-described example, the pressing portion 51 presses the first blade body 10 downward (toward the second blade body 20). However, for example, the pressing portion 51 may not be provided as long as the first blade body 10 can be pressed by the first screw SC1. However, the first blade body 10 may be elastically pressed against the second blade body 20 by the pressing portion 51 because a force with which the optical fiber 70 is sandwiched between the fiber grooves F1 and F2 is likely to be uniform.

In addition, in the above-described example, the first blade body 10 and the positioning pins 30 are configured to be movable, and the second blade body 20 is fixed, but the members configured to be movable can be changed as appropriate. For example, the blade bodies 10 and 20 may be configured to be movable, and the positioning pins 30 may be fixed (refer to second embodiments). In addition, only one of the blade bodies 10 and 20 and the positioning pins 30 may be movable, or all of the blade bodies 10 and 20 and the positioning pins 30 may be movable. That is, at least one of the blade bodies 10 and 20 and the positioning pins 30 may be movable.

As described above, the coating stripping device 1 according to one or more embodiments is a coating stripping device for stripping the coating 72 of the optical fiber 70, and includes: the first blade body 10 having the first facing surface 10a, the second blade body 20 having the second facing surface 20a that sandwiches the optical fiber 70 in the facing direction Z together with the first facing surface 10a; and the positioning pins 30 disposed between the first facing surface 10a and the second facing surface 20a in the facing direction Z, in which the first fiber groove F1 which extends in the axial direction X intersecting the facing direction Z and into which the optical fiber 70 is fitted to strip the coating 72, and the first positioning groove P1 which is disposed at a position different from the position of the first fiber groove F1 in the intersecting direction Y intersecting both the facing direction Z and the axial direction X and extends in the axial direction X and into which the positioning pin 30 is fitted are open to the first facing surface 10a, the second fiber groove F2 which extends in the axial direction X and into which the optical fiber 70 is fitted to strip the coating 72, and the second positioning groove P2 which extends in the axial direction X and into which the positioning pin 30 is fitted are open to the second facing surface 20a, and the distance L1 between the first fiber groove F1 and the first positioning groove P1 in the intersecting direction Y and the distance L2 between the second fiber groove F2 and the second positioning groove P2 in the intersecting direction Y are substantially equal.

With this configuration, the fiber grooves F1 and F2 can be positioned by the positioning pins 30 and the positioning grooves P1 and P2 provided in the blade bodies 10 and 20. Therefore, for example, compared to a case where a positioning protrusion portion is provided in the blade body, the highly accurate positioning of the fiber grooves F1 and F2 and the ease of manufacture are more easily realized.

In addition, at least one of the first blade body 10, the second blade body 20, and the positioning pins 30 is movable. With this configuration, the accuracy of positioning the fiber grooves F1 and F2 can be reliably increased.

In addition, the coating stripping device 1 according to one or more embodiments further includes the pressing portion 51 that applies a pressing force (that is, a pressing force which is directed downward) to the first blade body 10 in a direction in which the first facing surface 10a and the second facing surface 20a are brought closer to each other. With this configuration, a force with which the optical fiber 70 is sandwiched between the fiber grooves F1 and F2 can be made uniform, and the coating 72 can be easily stripped.

In addition, the coating stripping device 1 according to one or more embodiments further includes the gripping portion 60 that grips the optical fiber 70 and is relatively movable relative to the first blade body 10 and the second blade body 20 in the axial direction X. With this configuration, the coating 72 of the optical fiber 70 can be easily stripped.

In addition, the coating stripping device 1 according to one or more embodiments further includes the positioning mechanisms (the first tapered surface 80d and the second tapered surface 90d) that position the first blade body 10 and the second blade body 20 in the axial direction X. In a case where the first blade body 10 (or the second blade body 20) is movable as in one or more embodiments, there is a possibility that the blade bodies 10 and 20 are shifted in the axial direction X. Therefore, the coating stripping device 1 may have such a positioning mechanism.

In addition, a method of manufacturing the blade bodies 10 and 20 according to one or more embodiments includes: preparing the first plate 10′, which is to become the first blade body 10, and the second plate 20′, which is to become the second blade body 20; and in a state in which the first plate 10′ and the second plate 20′ are overlapped with each other such that the first processed surface 10a′, which is to become the first facing surface 10a in the first plate 10′, and the second processed surface 20a′, which is to become the second facing surface 20a in the second plate 20′, are located on the same plane, simultaneously forming the first fiber groove F1 on the first processed surface 10a′ and the second fiber groove F2 on the second processed surface 20a′, and simultaneously forming the first positioning groove P1 on the first processed surface 10a′ and the second positioning groove P2 on the second processed surface 20a′. With this configuration, the blade bodies 10 and 20 used in the coating stripping device 1 according to the above embodiments can be easily manufactured.

### Second Embodiments

Next, second embodiments will be described, but basic configurations thereof are the same as the configurations of the first embodiments. Therefore, the same configurations will be denoted by the same reference numerals, descriptions thereof will be omitted, and only different points will be described.

As shown in FIGS. 11A and 11B, a coating stripping device 2 according to one or more embodiments includes a second rotating portion 100 in addition to the rotating portion (first rotating portion) 50 described in the first embodiments. Similarly to the first rotating portion 50, the second rotating portion 100 is configured to be capable of rotating relative to the base 40 about the shaft body A as a rotation axis. In one or more embodiments, the above-described open state and closed state are switched by the rotating portions 50 and 100 rotating relative to the base 40.

The second blade body 20 is fixed to the second rotating portion 100 to be movable in the intersecting direction Y and the facing direction Z. More specifically, a stepped screw similar to the first screw SC1 is used as the second screw SC2. Then, the second screw SC2, which is a stepped screw, maintains the second blade body 20 in a movable state in the intersecting direction Y and the facing direction Z while restricting the second blade body 20 from falling off the second rotating portion 100. In other words, the second blade body 20 is attached to the second rotating portion 100 in a state in which a shift in the intersecting direction Y and the facing direction Z is allowed. Furthermore, in one or more embodiments, the optical fiber 70 and the positioning pin 30 are fixed to the base 40.

A pressing portion 101 is provided on a front surface of the second rotating portion 100. The pressing portion 101 applies a pressing force to the second blade body 20 in a direction in which the first facing surface 10a and the second facing surface 20a are brought closer to each other. Although not shown in detail, the pressing portion 101 has an urging member that urges the second blade body 20 upward. Accordingly, the pressing portion 101 applies an elastic pressing force (urging force) directed upward to the second blade body 20. The pressing portion 101 and the second fiber groove F2 may be at substantially the same position in the intersecting direction Y. As described above, in one or more embodiments, the two pressing portions 51 and 101 are provided to correspond to the two rotating portions 50 and 100 (blade bodies 10 and 20).

Also in one or more embodiments, when the optical fiber 70 is sandwiched between the fiber grooves F1 and F2, the fiber grooves F1 and F2 can be positioned by using the positioning grooves P1 and P2 and the positioning pins 30. That is, when the coating stripping device 2 is transitioned to the closed state, the blade bodies 10 and 20 in a movable state are fixed, by the pressing force received from the pressing portions 51 and 101, to the positions at which the positioning pins 30 and the positioning grooves P1 and P2 are fitted. Here, as described above, since the distance L1 and the distance L2 are substantially equal (see also FIG. 5A), when the blade bodies 10 and 20 are fixed, the first fiber groove F1 and the second fiber groove F2 are positioned with high accuracy. Therefore, the optical fiber 70 can be sandwiched between the fiber grooves F1 and F2 with a uniform force, and the coating 72 can be easily stripped.

In a case where the pressing portion 101 is provided in the second rotating portion 100, the pressing portion 51 may not be provided. That is, at least one of the pressing portion 51 that presses the first blade body 10 and the pressing portion 101 that presses the second blade body 20 may be provided. In a case where the blade bodies 10 and 20 can be pressed by the screws SC1 and SC2, the coating stripping device 2 may not include both the pressing portions 51 and 101.

The technical scope of the present invention is not limited to the above-described embodiments, and various modifications can be made without departing from the scope of the present invention.

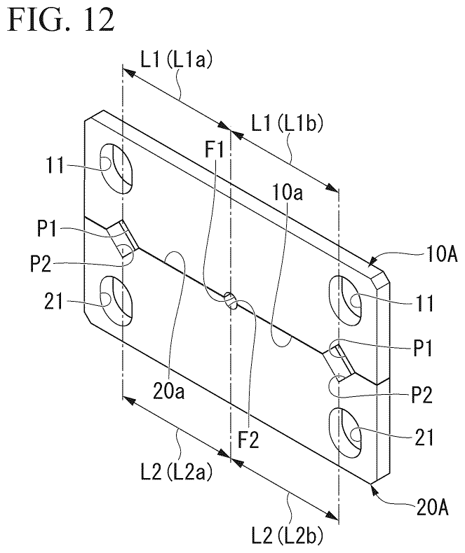

FIG. 12 is a view showing blade bodies 10A and 20A according to a modification example. As shown in the figure, the positioning grooves P1 and P2 may have a V-shape when viewed in the axial direction X. In this case, each of a pair of inclined surfaces of each of the positioning grooves P1 and P2 is in contact with the respective one of the positioning pins 30. A configuration in which the positioning grooves P1 and P2 are V-shaped has an advantage that the positioning grooves P1 and P2 are easily manufactured. On the other hand, a configuration in which the positioning grooves P1 and P2 are U-shaped has an advantage that it is easy to check processing accuracy after the positioning grooves P1 and P2 are processed.

In addition, the number of positioning pins 30 (and positioning grooves) can be changed as appropriate. For example, the coating stripping devices 1 and 2 may include only one positioning pin 30 (and positioning groove).

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1, 2: Coating stripping device
10, 10A: First blade body
10a: First facing surface
10′: First plate
10a′: First processed surface
20, 20A: Second blade body
20a: Second facing surface
20′: Second plate
20a′: Second processed surface
30: Positioning pin
51, 101: Pressing portion
80d: First tapered surface (positioning mechanism)
90d: Second tapered surface (positioning mechanism)
F1: First fiber groove
F2: Second fiber groove
P1: First positioning groove
P2: Second positioning groove

1. A coating stripping device for stripping a coating of an optical fiber, comprising:
a first blade body having a first facing surface;
a second blade body having a second facing surface that sandwiches the optical fiber in a facing direction together with the first facing surface; and
positioning pins between the first facing surface and the second facing surface in the facing direction, wherein
a first fiber groove, into which the optical fiber is fitted to strip the coating, extends in an axial direction intersecting the facing direction,
a first positioning groove, into which one of the positioning pins is fitted, extends in the axial direction and is disposed at a different position from the first fiber groove in an intersecting direction intersecting both the facing direction and the axial direction
the first fiber groove and the first positioning groove are open to the first facing surface,
a second fiber groove, into which the optical fiber is fitted to strip the coating, extends in the axial direction coating,
a second positioning groove, into which one of the positioning pins is fitted, extends in the axial direction,
the second fiber groove and the second positioning groove are open to the second facing surface, and
a distance between the first fiber groove and the first positioning groove in the intersecting direction is substantially equal to a distance between the second fiber groove and the second positioning groove in the intersecting direction.

2. The coating stripping device according to claim 1, wherein at least one of the first blade body, the second blade body, and the positioning pins is movable.

3. The coating stripping device according to claim 1, further comprising a press that applies a pressing force to at least one of the first blade body and the second blade body in a direction in which the first facing surface and the second facing surface are brought closer to each other.

4. The coating stripping device according to claim 1, further comprising a grip that grips the optical fiber and is movable relative to the first blade body and the second blade body in the axial direction.

5. The coating stripping device according to claim 1, further comprising a positioner that positions the first blade body and the second blade body in the axial direction.

6. A method of manufacturing a blade body used in the coating stripping device according to claim 1, the method comprising:
providing a first plate for the first blade body and a second plate for the second blade body in an overlapping state in which the first plate and the second plate overlap each other such that a first processed surface of the first plate is on a same plane as a second processed surface of the second plate; and
in the overlapping state:
simultaneously forming the first fiber groove on the first processed surface and the second fiber groove on the second processed surface, and
simultaneously forming the first positioning groove on the first processed surface and the second positioning groove on the second processed surface, wherein
the first processed surface is the first facing surface of the first blade body, and the second processed surface is the second facing surface of the second blade body.
